(19) United States
(12) Patent Application Publication
(10) Pub. No.: US 2003/0059509 A1
(43) Pub. Date: Mar. 27, 2003

(54) Method and apparatus for peeling citrus fruit

(76) Inventor: Simon Surinder Pal Grewal, Essex (GB)

Correspondence Address: BAKER + HOSTETLER LLP, WASHINGTON SQUARE, SUITE 1100, 1050 CONNECTICUT AVE. N.W., WASHINGTON, DC, 20036-5304, US

(21) Appl. No.: 10/169,871

(22) PCT Filed: Dec. 18, 2000
(86) PCT No.: PCT/GB00/04860

(30) Foreign Application Priority Data
Jan. 10, 2001 (GB) 0000481.2

(51) Int. Cl. A23P 1/00

(52) U.S. Cl. 426/482

(57) ABSTRACT

A method and apparatus for preparing segments from a citrus fruit (10) having a flesh portion (11), and albedo portion (12), a peel portion (13) and a longitudinal axis (14). The peel portion and part of the albedo portion are sliced without piercing the flesh portion and the fruit submersed in liquid under a vacuum to extract air from the albedo portion. The fruit (10) is subjected to high pressure while submerged under the liquid so that the liquid infuses into the albedo portion (12) to loosen the peel portion (13) and albedo portion from the fruit portion. The peel potion and albedo portion are then removed from the fruit portion to produce peeled fruit. In preferred embodiments of the invention, the fruit is divided into segments centrifugally by rotating the fruit at high speed about the longitudinal axis and the segments are coated with citrus oil and ascorbic acid.

This invention relates to a method and apparatus for peeling citrus fruit and in particular for producing skinned segments.

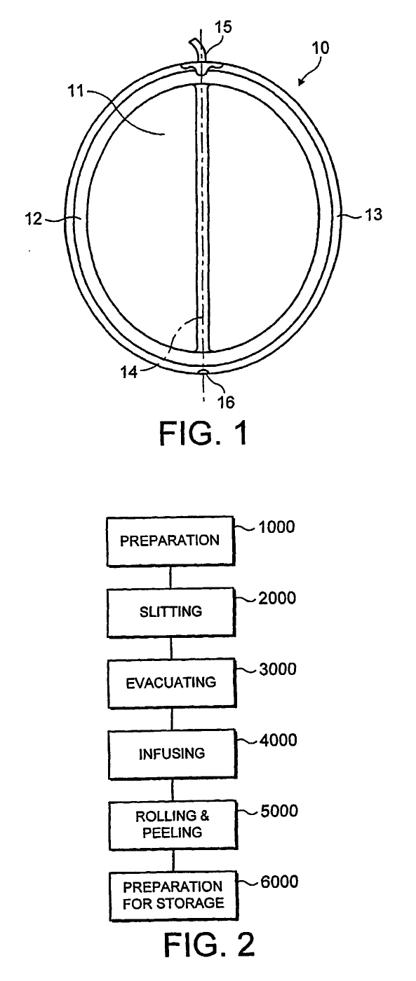

A vertical cross section of a citrus fruit is shown in FIG. 1 where a citrus fruit 10 has a fruit portion divided into segments 11 surrounded by a spongy layer, the albedo 12, which is itself is surrounded by a thin waxy outer layer, the peel or cuticle 13. The segments are covered by a segment membrane. A citrus fruit is typically more or less spheroid having a longitudinal axis 14 passing through a stem end 15 and a blossom end 16. The albedo is mostly composed of pectin, cellulose and hemi-cellulose with numerous air sacs, an average grapefruit may contain up to 200 ml of air in these air sacs.

It is well know in the art to use enzymes to assist in the removal of the peel and albedo from the fruit portion of a citrus fruit, the enzymes being used to at least partially digest the pectin and cellulose and thereby loosen the peel.

Thus, it is known from U.S. Pat. No. 4,284,651 to produce segments from citrus fruits using an enzyme. The fruit is first heated so that the core is at 20° to 40° C. and the surface at 40° to 60° C., which takes 10 to 60 minutes. The peel is scored to barely penetrate the albedo and the fruit submerged in pectinase under a vacuum of 25 to 30 ins of mercury (85 to 102 kPa) at a temperature of 20° to 50° C. to remove air from the air sacs in the albedo. Pectinase then enters the air sacs when the vacuum is released. It may be necessary to repeat the process to remove sufficient of the air. The fruit is then incubated for 15 mins to 2 hours at a temperature of 30° to 60° C. in an oven, in order for the enzyme to dissolve some of the pectin and cellulose in the albedo and loosen the peel. The fruit can then be mechanically peeled and segmented by “hand, scoop, section knives” from the core.

U.S. Pat. No. 5,000,967 discloses an alternative use of enzymes in which lower temperatures are used and the enzyme is infused into the albedo using raised pressures without the use of a vacuum to extract the air. Thus, the core and surface of the fruit are maintained at below 40° C. and the peel is scored into wedges, rings, spirals or is grated or scratched. The fruit is submerged in an enzyme at room temperature and 6 to 10 pressure pulses of 20 to 40 p.s.i (180 to 276 kPa) are applied for 15 seconds with breaks between the pulses of 5 seconds. The fruit is incubated at less then 30° C. for 1 to 2 hours. This process is said to provide improved ease of peeling and less adhering albedo than in the vacuum infusion method with more segments being removed. It is supposed that the pulse pressure tends to flex the peel to work the enzyme solution through the albedo. This process has the advantage over the earlier process that because the enzyme is maintained at about room temperature, the enzyme can be reused for 9 to 10·batches, whereas in the previous process the effectiveness of the enzyme was destroyed after one use by the higher temperatures.

Methods of peeling whole citrus fruits, rather than producing segments, are known from U.S. Pat. Nos. 5,196,222 and 5,200,217.

U.S. Pat. No. 5,196,222 discloses a process in which the peel of the fruit is first perforated to allow enzymes to access the albedo then the fruit is orientated so that it rotates on the longitudinal axis 14 through the stem so that a single equatorial cut can be made through the peel by knifes urged towards the fruit. The fruit is then infused with a fluid beneath the outer surface, using either a vacuum or pressure method and incubated at less than 20° C. for 10 to 16 mins. The fruit is then peeled manually, although the disclosure speculates that peeling could be automated, and the fruit is brushed to remove the strings of cellulose before being cooled and packaged.

In U.S. Pat. No. 5,200,217, the fruit is first chilled below 10° C. and preferably to 5° to 8° C. so that the enzyme will not affect the fruit portion in the subsequent infusion. The fruit is infused with the enzyme at 35° C. either using a vacuum of 25 to 30 inches of mercury (85 to 120 kPa) or using pressure pulses of 20 to 40 psi (180 to 276 kPa), using 15 second pluses with 5 second gaps between the pulses. The fruit then has to be incubated for 20 to 90 minutes depending on the time within the harvesting season and it is stated that in this time there is insufficient time for the core to warm and therefore for the enzyme to affect the fruit portion to any large extent.

The use of enzymes, therefore, normally requires the raising of the temperature of the fruit and long incubation times. The raised temperatures tend to destroy vitamin C and flavonoids in the fruit and the enzymes require long incubations periods in order partially to dissolve the albedo to loosen the fruit. Special precautions have to be taken to mitigate enzyme attack on the fruit portion. Moreover, manual peeling and, where required, segmenting of the fruit, are normally required as part of the process.

U.S. Pat. No. 5,560,951 discloses a non-enzymatic method of peeling a citrus fruit. In this process, the fruit is washed and held for 30 minutes at 25° to 45° C. and scored with longitudinal cuts before being infused with water either under a vacuum of 3 kPa for 3 minutes which is slowly released over the succeeding 3 minutes, or is infused under pressure at 203 kPa using compressed air in which 10 pulses of 15 seconds are applied to the fruit. Subsequent to infusion, it is disclosed that there is no advantage in incubating the fruit which has been infused with water as there is with fruit infused with enzymes. The fruit is then peeled by hand. It is disclosed that peeling time is actually longer for grapefruit using water infusion than for enzyme infusion but comparable with the peeling times using enzymes for oranges and tangelos. It is further disclosed that there is less juice leakage and softening during storage with water infusion than with enzyme infusion, which may be due to enzyme penetrating into the fruit portions in the enzyme methods. Peeling of the water infused fruit was, however, hampered by incomplete hydration of the albedo, particularly in the pressure method. According to the disclosure, the segments did not become slimy with storage as is experienced using enzyme. Problems were disclosed of dry albedo using the lower temperature of the process, in particular with the low pressure infusion process and where there were substantial air spaces or slightly desiccated peels.

It is, therefore, apparent that the enzyme methods known in the art result in some damage to the fruit, require long processing times and result in poor shelf life. The pressure or temperature infusion methods with water result in some problems with manual peeling because of sections of dry albedo. The pressure methods of the prior art require pressure pulsing.

It is an object of the present invention to at least partially alleviate the foregoing difficulties.

According to a first aspect of the present invention there is provided a method for preparing citrus fruit including the steps of: a) providing a citrus fruit having a flesh portion, an albedo portion, a peel portion and a longitudinal axis; b) piercing the peel portion to provide access to the albedo portion without piercing the flesh portion; c) submerging the fruit in a liquid under vacuum to extract air from the albedo portion; d) subjecting the fruit submerged in the liquid to pressure to produce infused fruit in which the peel portion and the albedo portion are loosened from the fruit portion; e) removing the peel portion and the albedo portion from the fruit portion to produce peeled fruit; and f) preparing the fruit portion for consumption or storage.

Conveniently, the step a) of providing a citrus fruit includes washing the fruit.

Advantageously, the washing step includes the steps of wetting the peel portion with water and detergent, and brushing the peel portion and rinsing the peel portion with water.

Conveniently, the step a) of providing a fruit includes a step of grading the fruit by size.

Conveniently, the step b) of piercing the peel portion to provide access to the albedo portion includes cutting through the peel portion into the albedo portion to produce slit fruit so as to facilitate subsequent removal of the peel and albedo portions from the fruit portion of the slit fruit.

Advantageously, the step of cutting through the peel portion comprises cutting the peel portion with latitudinal cuts transverse to the longitudinal axis to form rings of peel.

Conveniently, the step c) of submerging the fruit in a fluid under vacuum comprises submerging the fruit under water in a vacuum in the range 51 to 100 kPa below atmospheric pressure.

Preferably, the step c) of submerging the fruit in a fluid under vacuum comprises submerging the fruit under water in a vacuum of about 95 kPa (950 mbar) below atmospheric pressure.

Conveniently, the step d) of subjecting the fruit submerged in the fluid to pressure comprises subjecting the fruit to a pressure in the range 400 kPa to 20,000 kPa.

Preferably, the step d) of subjecting the fruit submerged in the fluid to pressure comprises subjecting the fruit to a pressure of about 4,000 kPa.

Conveniently, the step e) of removing the peel portion and the albedo portion from the fruit portion includes pressing the infused fruit a predetermined amount to loosen the peel portion and the albedo portion from the fruit portion to produce pressed fruit.

Preferably, the step of pressing the infused fruit includes passing the infused fruit between brush rollers and contoured bars separated from the brush rollers by a distance 1 cm to 3 cm less than a diameter of the infused fruit.

Advantageously, the step e) of removing the peel portion and the albedo portion from the fruit portion includes brushing the peal portion and albedo portion from the fruit portion.

Conveniently, the step of brushing the peel portion and albedo portion from the fruit portion comprises brushing the fruit in a direction substantially parallel with the longitudinal axis.

Conveniently, the step f) of preparing the fruit portion for consumption or storage includes segmenting the fruit portion into segments.

Advantageously, the step of segmenting the fruit portion into segments comprises rotating the peeled fruit about the longitudinal axis of the fruit to separate the segments centrifugally.

Conveniently, the step f) of preparing the fruit portion for consumption or storage comprises the further step of removing outer membranes from the segments with acid.

Advantageously, the further step of removing outer membranes from the segments with acid comprises removing the outer membranes with dilute citric acid and/or dilute hydrochloric acid.

Preferably, the step of removing the outer membranes with dilute citric acid and/or dilute hydrochloric acid comprises passing the segments for 1-3 minutes through a bath containing a solution in the proportions of 1 gm of citric acid: 100-200 ml of water: 5 ml dilute hydrochloric acid, the solution having a pH in the range 0.88 to 0.91.

Conveniently, the step of removing the membranes with acid comprises the further steps of draining acid from the segments and neutralising any of the acid by immersing the segments in an alkaline solution.

Conveniently, the step of immersing the segments in an alkaline solution includes the step of dissolving any remaining segment membrane in the alkaline solution.

Preferably, the step of immersing the segments in an alkaline solution comprises immersing the segments in dilute sodium hydroxide at a temperature in the range 50° C. to 60° C. for 1-3 minutes.

Preferably, the step f) of preparing the fruit for consumption or storage includes agitating and rinsing the segments in cold water.

Advantageously, the step f) of preparing the fruit for consumption or storage includes chilling the segments in cold water, drying the segments and coating the segments.

Conveniently, the step of chilling the segments in cold water comprises chilling the segments in water at a temperature in the range 0° C. to 2° C.

Preferably, the step of coating the segments comprises coating the segments with ascorbic acid 0.5% and/or citrus oil 0.5%.

According to a second aspect of the invention there is provided an apparatus for preparing citrus fruit having a longitudinal axis, a peel portion, an albedo portion containing air sacs, and a fruit portion, the apparatus comprising: cutter means having knife means for cutting through the peel portion and into the albedo portion, and having depth control means for preventing blade means of the knife means penetrating the fruit portion, for cutting substantially parallel latitudinal circumferential cuts through the peel portion into the albedo portion to form peel rings transverse to the longitudinal axis; vacuum means for extracting air from the air sacs to form at least partially evacuated air sacs; pressure means for infusing liquid under pressure into the at least partially evacuated air sacs to loosen the peel rings and albedo portion from the fruit portion; brush means having a brush longitudinal axis substantially perpendicular to the fruit longitudinal axis for brushing the peel rings and albedo portion off the fruit portion; and centrifugal segmentation means for rotating the fruit portion about the fruit longitudinal axis to separate the fruit portion into the constituent segments thereof by centripetal forces.

According to a third aspect of the invention there is provided a cutter, for use in the method described above, for providing access to the albedo portion of a citrus fruit, the cutter comprising: conveyor and rotator means for conveying fruit through the cutter and for rotating the fruit about a longitudinal axis thereof; an array of cutter knives biased towards the conveyor and rotator means for cutting a plurality of latitudinal slits, transverse to the longitudinal axis, through the peel portion and into the albedo portion; and depth control means for preventing the cutter knives piercing the fruit portion.

Conveniently, the cutter knives each comprise an L-shaped blade holder having a first arm and a second arm shorter than the first arm, the first arm housing a protruding blade; the blade holder being pivotable about a pivot point adjacent a junction between the first arm and the second arm; and the cutter further comprising: pivot means passing through the pivot point; bias means acting on the second arm to bias the first arm towards the conveyor and rotator means; and stop means such that the blade holder is rotatable about the pivot point between a rest position in which the second arm abuts the stop means to limit downward rotation of the first arm and an upper position in which the first arm abuts the stop means to limit upward rotation of the first arm.

Advantageously, the depth control means comprises a shoulder between the blade holder and the blade for engaging an outer surface of the peel to allow the blade to penetrate only a predetermined distance through the peel portion and into the albedo portion.

According to a fourth aspect of the invention there is provided an infuser, for use in the method described above, the infuser comprising: an evacuation and pressure vessel; a vacuum reservoir connectable to the evacuation and pressure vessel rapidly partially to evacuate the evacuation and pressure vessel, the vacuum reservoir being evacuable by a vacuum pump connectable thereto; a pressure pump connectable to the evacuation and pressure vessel for filling the evacuation and pressure vessel with a liquid under pressure; and pressure release means for permitting the liquid in the evacuation and pressure vessel to be returned to atmospheric pressure.

According to a fifth aspect of the invention there is provided a roller presser, for use in the method described above, the roller presser comprising brush rollers and contoured bars separated from the brush rollers by a distance 1-3 cm less than a diameter of infused fruit to be pressed, such that the fruit is pressed a predetermined amount as the fruit is passed between the rollers and the contoured bars.

According to a sixth aspect of the invention there is provided a brusher, for use in the method described above, the brusher including parallel roller brushes, each roller brush having a roller brush rotational axis, the roller brushes being for conveying fruit through the brusher and the brusher further including two counter-rotatable transverse brushes having substantially parallel transverse brush rotational axis, wherein the transverse brush rotational axes are substantially transverse to the roller brush rotational axes and substantially parallel to a direction of motion of fruit through the brusher, such that when fruit is passed between a roller brush and the two transverse brushes the transverse brushes act to brush peel and albedo portions from a fruit portion of the fruit.

According to a seventh aspect of the invention there is provided a segmenter, for use in the method described above, the segmenter including: two spaced apart rotatable drums defining a valley therebetween, delivery means for delivering peeled fruit to the valley for rotation by the drums therein, such that centripetal forces set up by rotation of the fruit by the drums causes the peeled fruit to divide into constituent segments thereof.

Conveniently, the segmenter further includes water jet means for spraying the rotating fruit with water to assist in passage of the segments through the valley.

According to an eighth aspect of the invention there is provided an acid for use in an acid bath, for use in the method described above, comprising a mixture in the proportions of 1 gm of citric acid: 100-200 ml of water: 5 ml dilute hydrochloric acid, the solution having a pH in the range 0.88 to 0.91.

Conveniently, the alkaline solution used in the alkali bath, used in the method described above, is obtainable by dissolving sodium hydroxide crystals in water in the proportion of 1 gm of sodium hydroxide crystals to 100 ml of water.

According to a ninth aspect of the invention there is provided a coating for coating segments of citrus fruit, for use in the method described above, the coating comprising ascorbic acid 0.5% and citrus oil 0.5%.

A specific embodiment of the invention will now be described by way of example with reference to the accompanying drawings in which:

FIG. 1 shows a diagrammatic view of a vertical cross section of a citrus fruit;

FIG. 2 shows a flow diagram of the principal steps of the method of the invention;

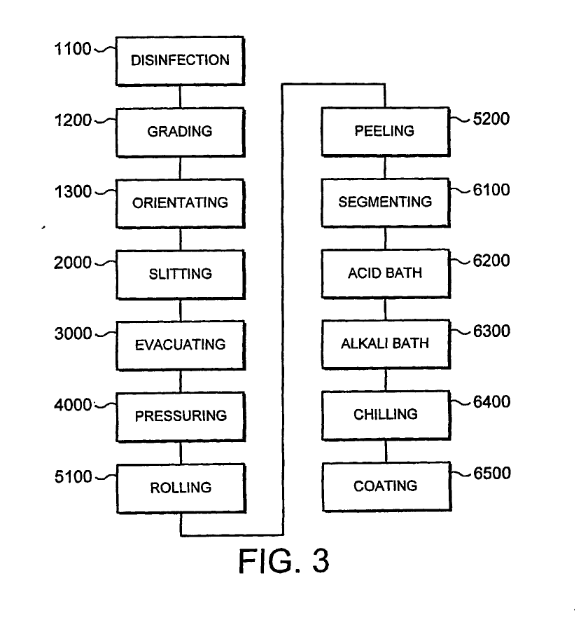

FIG. 3 shows in flow diagrammatic form the method of FIG. 2 in more detail;

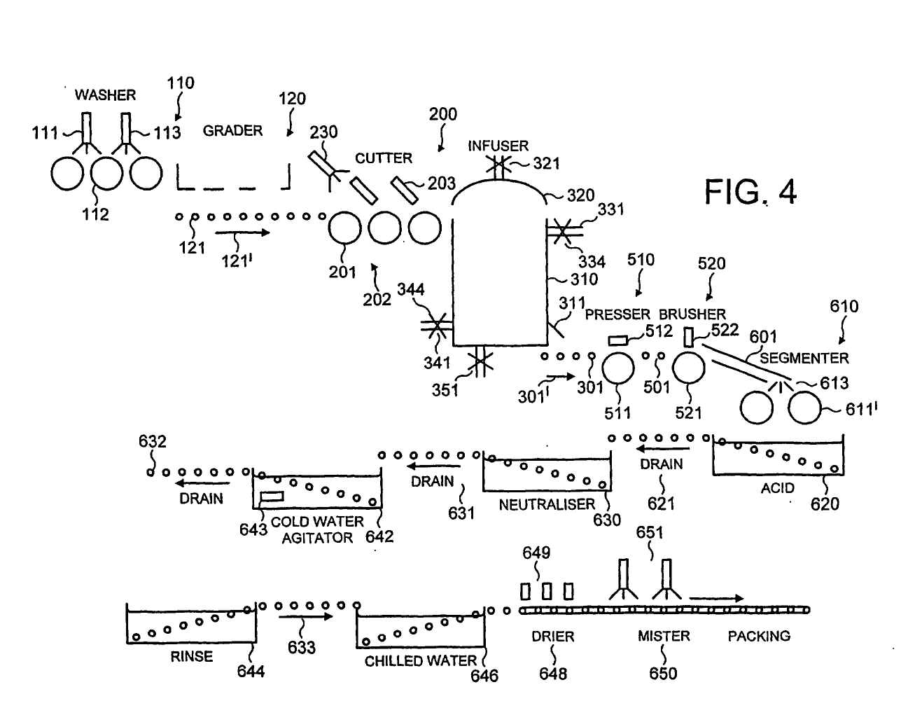

FIG. 4 shows a diagrammatic view of an apparatus used in carrying out the method of FIG. 2.

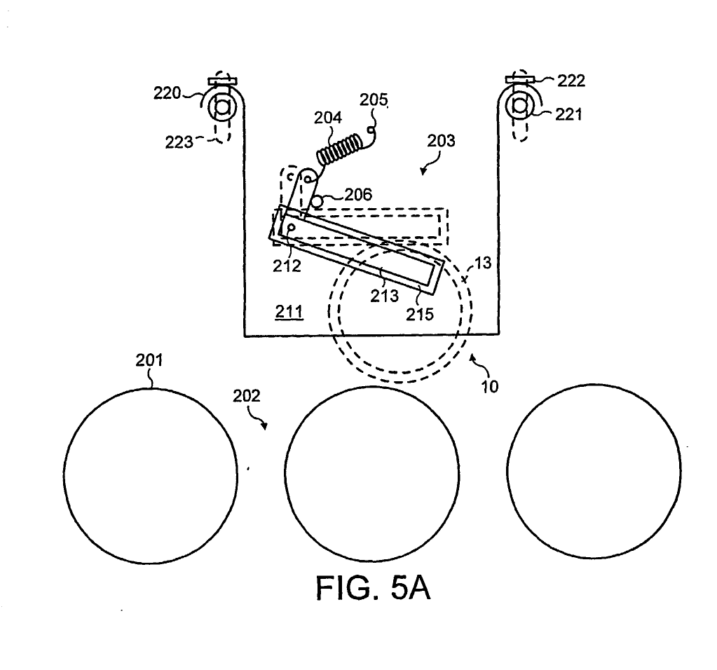

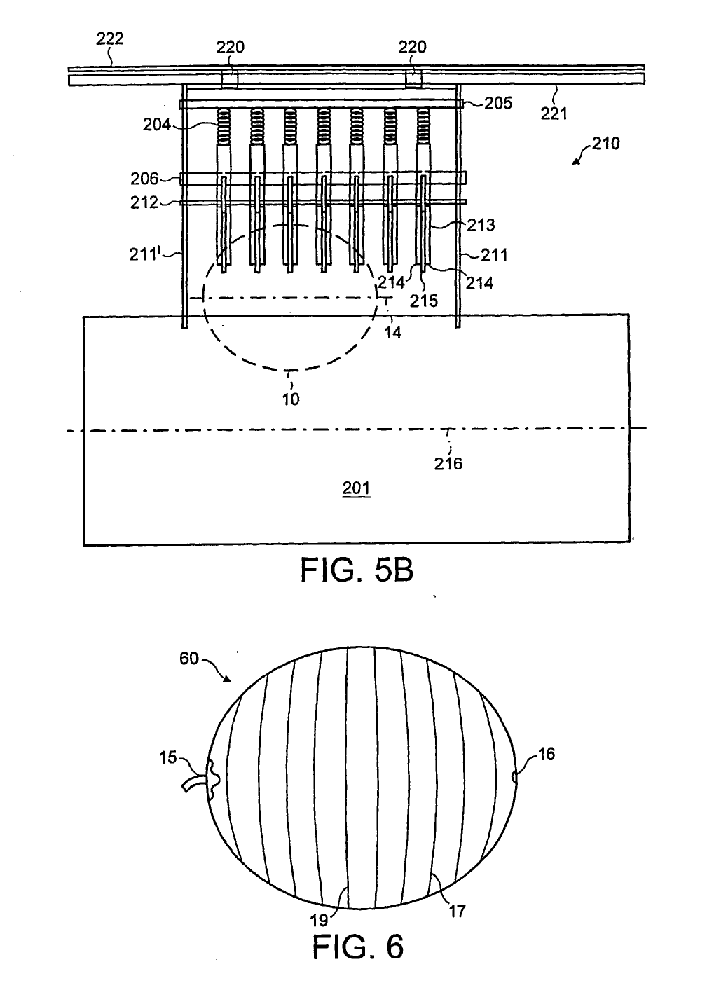

FIG. 5A shows a schematic side view of the cutter of one aspect of the present invention;

FIG. 5B shows a schematic end view of the cutter of FIG. 5A;

FIG. 6 shows a citrus fruit cut using the cutter of FIGS. 5A & 5B;

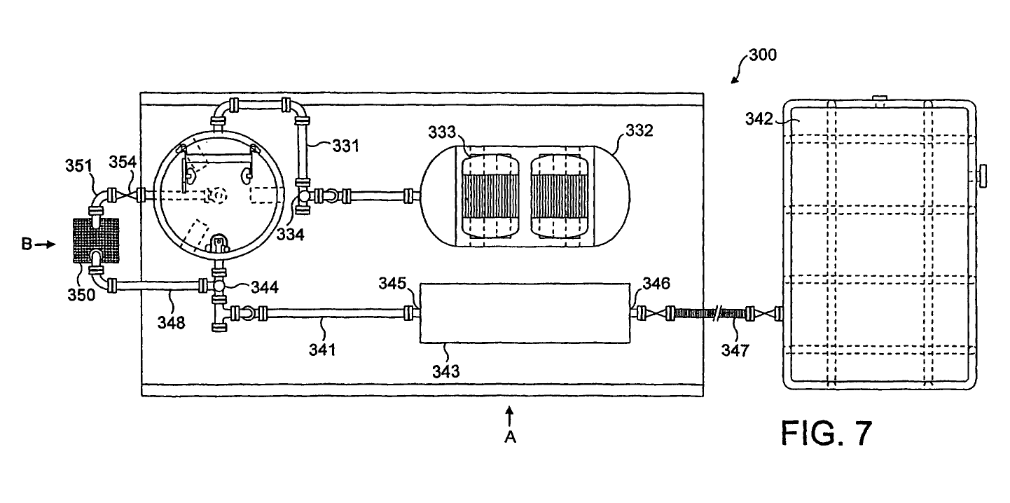

FIG. 7 shows a plan view of the infuser used in the present invention;

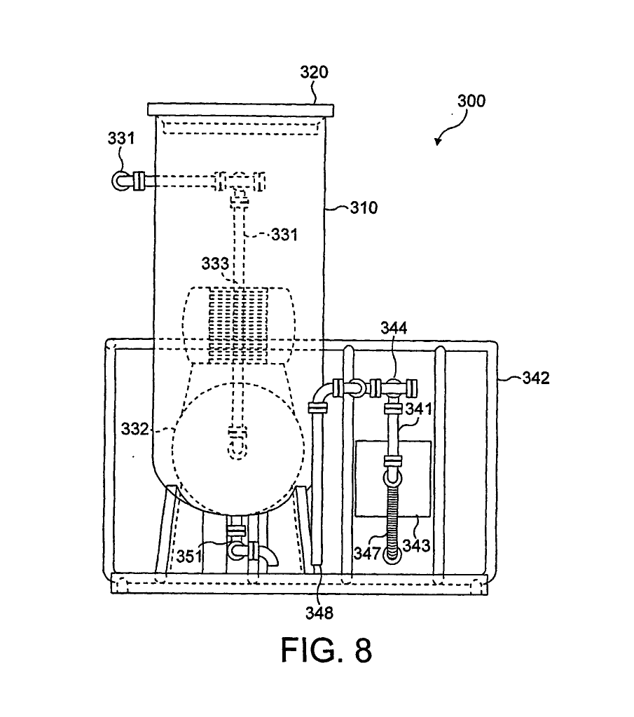

FIG. 8 shows an end view of the infuser of FIG. 7; and

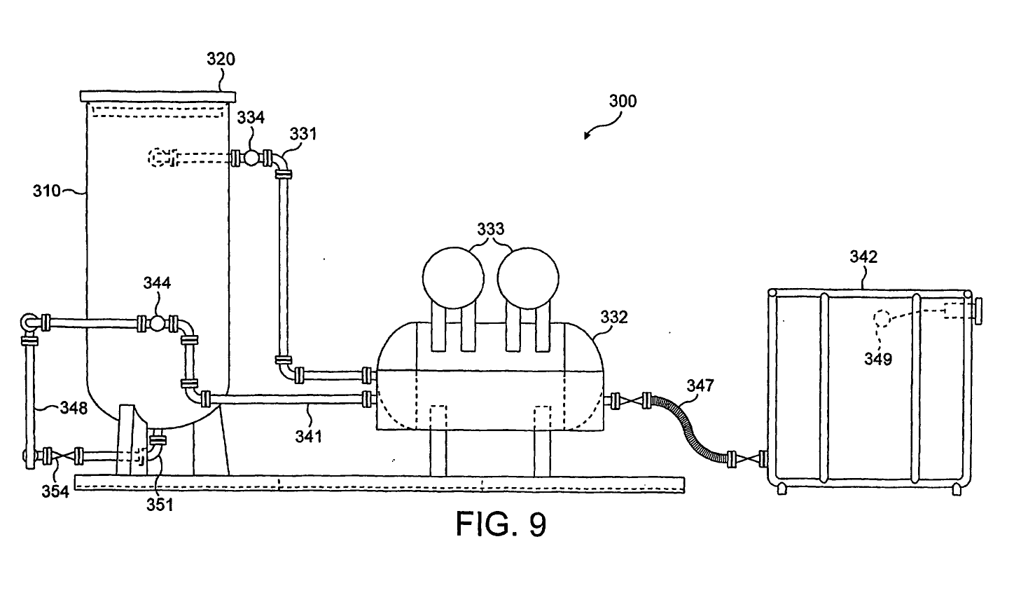

FIG. 9 shows a side view of the infuser of FIG. 7;

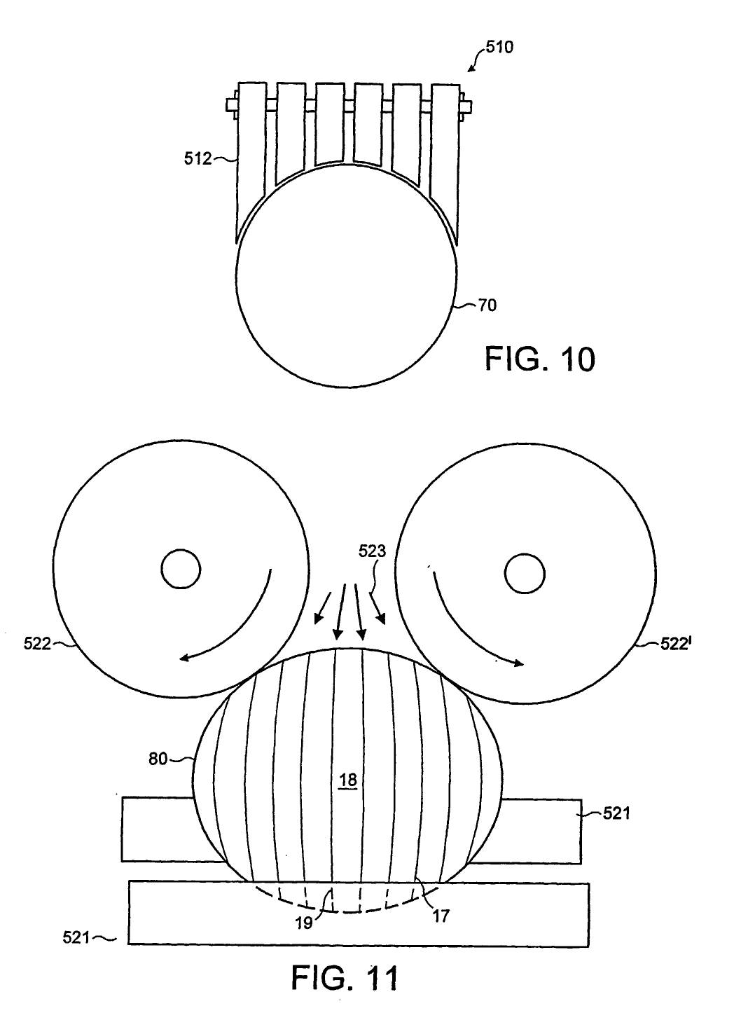

FIG. 10 shows a schematic view of the pressure roller used in the present invention;

FIG. 11 shows a schematic view of the peeler of an aspect of the present invention; and

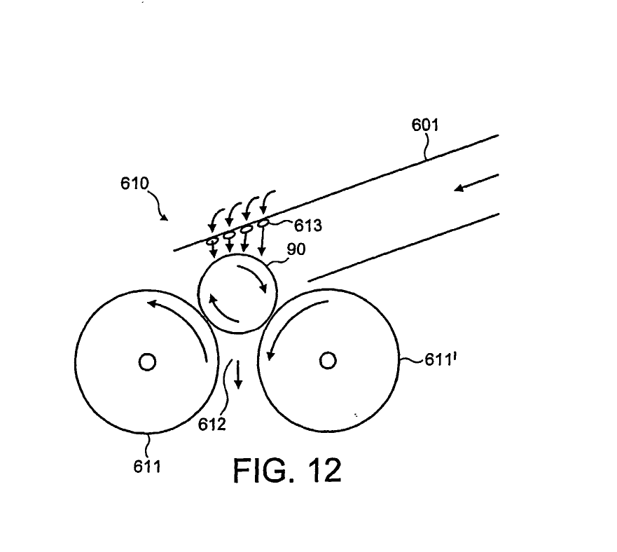

FIG. 12 shows a schematic view of the segmenter of an aspect of the present invention.

In the figures, like reference numerals denote like parts or steps.

The method of the invention is shown in outline in FIG. 2. Referring also to FIG. 1, following preparation of the fruit, step 1000, the peel 13 is slit, step 2000, through to the albedo 12 without piercing the segments 11. The fruit is then immersed in water and subjected to a vacuum to remove, step 3000, at least some of the air from air sacs in the albedo 12. The vacuum is released and water infuses, step 4000, into the former air sacs and this is assisted by increasing the pressure of the water to 4000 kPa (40 bar). At this pressure the water may behave as a super-solvent to dissolve the pectin and softens the albedo, cellulose and hemi-cellulose to such an extent that they can subsequently be removed by mechanical means. The fruit is pressure rolled to further loosen the peel and mechanically peeled, step 5000, and then the fruit portions are prepared for consumption or storage, step 6000.

A schematic view of apparatus using the process of the invention is shown in FIG. 4.

Water jets 111 and revolving brushes 112 are provided to disinfect fruit 10 to be peeled, by thoroughly wetting the surface of the fruit by the water jets 111 and by brushing the outer surface of the peel 13 with water and detergent as the fruit is moved over the revolving brushes 112 to remove field oils, soil, mould and dust. This is followed by a further water jet 113 to provide a fresh water rinse.

A grader 120, known per se, is provided to grade the fruit by size to ensure that the fruit is processed by subsequent stages of the apparatus adjusted for the particular graded size of fruit. Thus, for example, one size of fruit may be passed through the remaining parts of the apparatus at a time, or separate channels through the apparatus may be provided for different sizes of fruit. It is found in practice, that grading into three sizes of small, medium and large is sufficient. A known first conveyor 121 is provided to pass the fruit from the grader 120 to a cutter or slitter 200, in the direction of arrow-headed line 121′, for slitting the peel 13 and partially piercing the albedo 12 without scoring or piercing the fruit segments 11.

Brush rollers 201 are provided to carry fruit through the cutter so that as the fruit enters the cutter it is orientated in a valley 202 between two rotating rollers so that its longitudinal axis 14 is parallel with the longitudinal axes 216 of the rollers 201, see FIG. 5B. Cutter knives 203 are located above the rollers 201 and are pivotally biased towards the rollers as best seen in FIGS. 5A and 5B. As best seen in FIG. 5B, the knives 203 are supported in knife assemblies such that a series of parallel knives are supported along the length of, but transverse to, a roller 201 to produce parallel latitudinal cuts in the peel. Further assemblies of knives are provided above further rollers so that as the fruit progresses through the cutter further latitudinal cuts may be provided by the further cutters. The cutters over different rollers may be off-set with respect to each other to provide offset latitudinal cuts which are closer together than otherwise would be possible with a single array of knives.

The structure of the cutter assemblies is best shown in FIGS. 5A and 5B. The knives 203 are supported in an open-ended cutter housing 210 having opposed walls 211, 211′. The cutter knives 203 are pivotally fixed to pivot rods 212, passing between the two opposed housing walls 211, 211′. The cutter knives 203 include cutter blades 215 held in cutter blade holders 213 which are substantially L-shaped, a first arm of the L-shaped blade holder 213 being aligned with the blade 215. A second arm, shorter than the first arm of the L-shaped blade holder 213, is connected near its end remote from the longer arm of the L-shaped blade 213 by an extension spring 204 to a spring bar 205, also connected between the opposed walls 211, 211′, to bias an end of the longer arm of the cutter knife 203 remote from the pivot 212 downwards towards the rollers 201. A further bar, to act as a stop bar 206, is provided between the opposed housing walls 211, 211′, such that the shorter arm of the L-shaped blade holder 213 engages the bar 206 in a rest position, with the knife 203 at an acute angle to the horizontal. The stop bar 206 also limits upward movement of the cutter knife 203 to a location in which the longer arm of the blade holder 213 is substantially horizontal, as shown by broken lines in FIG. 5A, in which location the longer arm of the blade holder bears on the stop bar. As shown in FIGS. 5A and 5B, the blade 215 protrudes below the blade holder 213 so that there are shoulders 214 of the blade holder 213 on each side of the blade. The shoulders 214 limit penetration of the blade 215 through the albedo 12 of the fruit 10 to be cut, to produce fruit 60 of which the peel 13 and albedo 12 have been slit, as shown in FIG. 6.

Water jets 230 are provided to play on the cutting knives 203, to lubricate and clean the blades 215.

The cutter assembly 210 is mounted in the apparatus such that the distance between the cutter knives 203 and the rollers 201 can be adjusted to accommodate 5 fruit 10 of different graded sizes, so that the blade 215 cuts into the albedo without piercing the segments 11. In the embodiment illustrated in FIGS. 5A and 5B, the cutter assembly is provided with hooks for engaging supporting rods 221 supported parallel to and above valleys 202. The hooks 220 are clamped onto the rods 221 by clamping bars 222 to prevent the assembly 210 rising up as a fruit 10 passes between the cutter knives 203 and the rollers 201. The supporting rods are removeably fixed to elongate apertures 223 in brackets (not shown) on walls (not shown) of the cutter to allow upward and downward adjustment of the supporting bars 220 relative to the rollers 210.

As illustrated, fruit 60, the peel and albedo of which have been slit by the cutter blades 203, see FIG. 6, is passed directly to an infuser 300, but known conveyer means may alternatively be provided.

The infuser 300, as best seen in FIG. 7, 8 and 9, includes a stainless steel, cylindrical, pressure vessel 310 provided with a hermetically sealable circular lid 320. The lid 320 may be bolted securely, with an intervening gasket seal (not shown), to the pressure vessel 310. The lid 320 is provided with a release valve 321 (see FIG. 4) to bleed air out of the pressure vessel 310 as the pressure vessel is filled with water and to bleed air into the pressure vessel 310 as the pressure vessel is drained of water.

The pressure vessel 310 is connected by stainless steel vacuum piping 331 to a vacuum reservoir 332. The vacuum reservoir 332 in turn is connected to a vacuum pump 333. The purpose of the vacuum reservoir 332 is to effect rapid evacuation of the pressure reservoir 332, to save processing time. An air valve 334 is provided in the vacuum piping 331 to isolate the pressure vessel 310 from the vacuum reservoir 332.

The pressure vessel is further connected by stainless steel high pressure water piping 341 to an outlet 345 of a high pressure water pump 343. A water valve 344 is provided in the water piping 341 to isolate the pressure vessel 310 from the high pressure water pump 343. An inlet 346 of the high pressure water pump 343 is connected by inlet piping 347 to a water reservoir 342 which is connected to a water mains. The water reservoir 342 is provided with a float valve 349 to regulate a supply of water from the water mains to the water reservoir 342.

The pressure vessel 310 is further connected by drainage piping 351, via a drainage valve 354 to a drain 350. A bypass path is also provided by bypass piping 348 from the water valve 344 to the drain 350.

The pressure vessel 310 may also be provided with stainless steel perforated baskets (not shown) for containing slit fruit 60 to be infused. Such baskets may be stackable one upon another within the pressure vessel. An uppermost basket may be provided with a perforated stainless steel lid to prevent fruit 60 floating out of the basket when the pressure vessel 310 is filled with water.

Removal means known per se are provided for removing infused fruit from the pressure vessel 310. This is shown schematically in FIG. 4 by a trap door 311, but where baskets are used the infused fruit 70 produced may be removed by lifting the baskets out of the pressure vessel 310.

A known conveyor 301 may be provided to pass the infused fruit 70 from the infuser 300 to pressure rollers 510, in the direction of arrow-headed line 301′.

As best shown in FIG. 10, and referring to FIG. 4, the pressure rollers comprise a bed of brush rollers 511, approximately 9 inches (22.5 cm) in diameter, spaced apart by gaps of approximately 1 inch (2.5 cm). The brush rollers are driven by an electric motor to revolve at about 600 r.p.m. Above the brush rollers 511 is an arrangement of contoured bars 512, arranged transversely to longitudinal axes of the brush rollers 511. The distance between the contoured bars and the brush rollers is adjustable such that the distance can be set to be approximately 1 cm less than the diameter of the infused fruit 70 to be pressed. The brushes of the brush rollers 511 are sufficiently deformable to allow fruit 70 to pass between the contour bars 512 and the brush rollers 512 without damaging the fruit 70, in a manner to be described.

A known conveyor 501 is provided to pass slit and squeezed fruit 80, emergent from the pressure roller bed 510, to a brusher 520.

As best seen in FIG. 11, the brusher 520 includes an array of parallel base rollers 521 to convey the slit and squeezed fruit 80 through the brusher and transverse rollers 522, 522′, having their longitudinal axes aligned with a direction of motion of the fruit 80 and transverse to longitudinal axes of the base rollers 521. The transverse rollers are mounted above the base rollers so that the fruit 80 is passable between the base rollers 521 and the transverse rollers 522, 522′. Valleys are provided between the base brush rollers 521 to align the longitudinal axis 14 of the fruit 80 with longitudinal axes of the base rollers. In this manner the latitudinal slits 17 cut in the fruit 80 are aligned with the longitudinal axes of the transverse rollers 522, 522′, so that the transverse brushes tend to drive rings of peel 18, defined by the latitudinal slits 17, off opposed ends 15, 16 of the fruit in the direction of the longitudinal axis 14 of the fruit, to produce peeled fruit 90. This removal of the peel and albedo is assisted by water jets 523 directed tangentially of the transverse brushes at points of contact between the fruit 80 and the transverse brushes 522.

A wide inclined tube 601, having an internal diameter greater than that of the peeled fruit 90, is provided to convey the peeled fruit 90 from the brusher 520 to a segmenter 610.

As best shown in FIG. 12, the segmenter includes two drum rollers 611, 611′ of larger diameter than the diameter of the fruit 90. The inclined tube 610 has an angled termination such that the lower end of the inclined tube is substantially horizontal, such that the fruit 90 is delivered by the inclined tube 601 to a valley 612 between the spaced apart rollers 611 and 611′. The drum rollers 611, 611′ revolve at between 1200 r.p.m. and 2500 r.p.m. to spin the fruit 90 such that the segments 11 of the fruit 90 are separated by centripetal forces. The width of the valley between the drum rollers 611 and 611′ can be varied for different types or graded sizes of fruit to permit segments to pass through the valley under gravity to a water conveyor system. Water jets 613 are provided in an upper surface of the inclined tube above the valley 612 between the drum rollers 611, 611′ to assist in the separation of the segments and their passage through the valley 612.

From the segmenter the segments 11 pass into a bath 620 of dilute citric acid and dilute hydrochloric acid. A suitable bath may be provided from a mixture in the proportions 100 ml to 200 ml of cold water: 1 gm citric acid crystals E(330): 5 ml of dilute hydrochloric acid (E507). The pH of the solution is preferably 0.88 but can be as high as 0.91. A heater (not shown) is provided to maintain the bath at 50° C. to 60° C.

A first draining conveyor 621 is provided to lift the segments from the acid bath and transfer them to a neutralising bath 630.

The neutralising bath 630 contains sodium hydroxide (1%) to neutralise any acid remaining on the segments and to remove any remaining hemi-cellulose and cellulose. The alkali solution may be prepared by mixing in the proportion 1 gm sodium hydroxide crystals (E524): 100 ml of water. This bath is also maintained at a temperature of 50° C. to 60° C. A temperature of 20° C. may be used but removal of the hemi-cellulose and cellulose takes longer at that temperature.

A second draining conveyor 631 is provided to lift the segments from the alkali bath and transfer them to a first chilled water bath 642. The first chilled water bath is provided with an agitator 643.

A third draining conveyor 632 is provided to lift the segments from the first chilled water bath and transfer them to a rinsing bath 644. A fourth draining conveyor 633 is provided to lift the segments from the rinsing bath and transfer them to a second chilled water bath 646 held at a temperature of 0° C. to 2° C. A fifth draining conveyor 648 is provided to lift the segments from the second chilled water bath. The segments subsequently pass on a flat conveyor belt beneath air knives 649 to remove excess moisture. The segments then pass on a conveyor 650 below a mister 651 under which the segments are coated with a mist of ascorbic acid 0.5% and citrus oil 0.5% before packing

The method of the invention using the above apparatus will now be described in more detail, referring in particular to FIG. 3.

Different types of citrus fruit, for example oranges and grapefruit, are processed separately from each other. Fruit 10 for peeling and segmenting is cleaned and disinfected, step 1100, by passing the fruit 10 over the revolving brushes 112 under the water jets 111 to remove field oils, soil, mould and dust using water and detergent. The fruit 10 is then rinsed under further water jets 113.

The fruit is passed from the fresh water rinse 113 to the known grader 121 for grading the fruit by size, step 1200. This allows fruit of different sizes to take different paths through remaining stages of the apparatus adjusted for that particular graded size or for different graded sizes to pass through the remaining stages at different times with the apparatus adjusted for the graded size being processed. In practice it has been found that three different graded sizes of any particular type of fruit provides sufficient differentiation.

The graded fruit is passed by the first conveyor 121 to the cutter 200. It is important to cut the peel 13 of the fruit 10 without damaging the segments 11, while allowing access to the air sacs in the albedo 12. It is also preferable to cut the peel in such a manner that the peel may be effectively mechanically removed at a later stage in the process.

The fruit is therefore first passed to a valley 202 between rotating brushes 201 which orientates, step 1300, the fruit with the longitudinal axis 14 of the fruit parallel with longitudinal axes 216 of the brushes 201. The brushes 201 pass the fruit 10 beneath the cutters 203. As the fruit passes over a roller beneath a cutter 203 the fruit lifts the cutter knives against the bias of the springs 204 so that the blades pierce the peel 13 and enter the albedo 12 to cut latitudinal circumferencial slits 17 in the peel and albedo, step 2000. The depth of the cut is restricted by the shoulders 214 on both sides of the blade 215 which engage and ride over the outer surface of the peel 13. The upward movement of the knives 203 is restricted by the stop bar 206 when the knives are substantially horizontal. The brushes of the brush rollers then deform sufficiently, if necessary, to allow the fruit 10 to pass under the raised cutter knives 203.

After slitting, the fruit is loaded into the infuser 300, possibly in baskets stacked one upon another. In a prototype apparatus four baskets were rested on top of each other in the pressure vessel 310. The uppermost basket is covered with a perforated stainless steel lid to prevent fruit floating out of the uppermost basket when water is introduced into the vessel. The lid 320 is hermatically sealed and the vacuum valve 334 and the drainage valve 351 are closed. A release valve 321 in the lid 320 is opened and the water valve 341 opened and the water pressure pump 343 switched on to pump sufficient water into the pressure vessel 310 from the storage reservoir 342 to submerge the fruit in water in the pressure vessel 310. This filling with water may be controlled by a timer (not shown) and terminated after a predetermined time. When the fruit is submerged with the pressure vessel partially full of water, with a space above the water level, the pump 343 is turned off and the bleed valve 321 and the water valve 344 are closed.

The vacuum reservoir 332 having been already evacuated by the vacuum pump 333, the vacuum valve 334 is opened to create, step 3000, a partial vacuum in the space above the water in the pressure vessel 310. A pressure 1000 mbar (100 kPa) below atmospheric pressure is preferred. This vacuum removes substantially all the air from the air sacs of the spongy albedo. A medium size orange may contain 100 ml of such air in the albedo and an average grapefruit 200 ml. This evacuation procedure takes about 60 seconds. The vacuum is then released by closing the vacuum valve 334 and re-opening the water valve 344. The water pump 343 is switched on and the relief valve 321 opened. The relief valve is re-closed when the pressure vessel is full of water, as indicated, for example, by water emerging from the relief valve. The water pump 343 is run until the pressure vessel is pressurised, step 4000, to 4000 kPa (40 bar), when the water valve 344 is closed and the water pump 343 switched off. The pressure vessel is maintained at pressure for about 60 seconds. At this much higher pressure than used in the prior art, water enters the former air sacs in the albedo to loosen the peel from the segments and may act as a super-solvent to dissolve most of the pectin in the albedo as well as any soluble hydrocarbons. The hemi-cellulose and cellulose are also softened to a gel.

The drain valve 351 and the relief valve 321 are opened to allow water, with the dissolved pectin and hydrocarbons, to drain from the pressure vessel 320 into the drain 350.

The hermatically sealed lid 320 is removed and the baskets of infused fruit removed from the pressure vessel. The high pressure water infusion of the invention yields cleaner citrus segments free from pith, strings and with a thinner pectin coating than in the prior art.

The fruit expands on infusion by some 11%. At this stage the albedo pulls off easily from the segments. The infused peel is only loosely adhering to the segment membranes and the peel may be loosened away from the segments by a gentle squeezing and rolling motion.

The fruit is therefore conveyed to pressure rollers 510 so that as the fruit falls onto a valley between brush rollers 511 the fruit is quickly aligned so that the longitudinal axis of the fruit is parallel to the longitudinal axes of the rollers. The brush rollers 511 convey the fruit under the contoured pressure bars 512 to squeeze, step 5100, the fruit by about 1 cm. Any excess pressure is absorbed by the flexible bristles of the brush rollers. The brush rollers deform and allow the fruit to move forward undamaged. The squeezing action also loosens the segments from each other ready for separation in a subsequent step of the method.

The fruit with loosely attached albedo and peel is conveyed by conveyor 501 to the brusher 520, where the peel and albedo are removed, step 5200, by the rotating transverse brushes 522, 522′, see FIG. 11. Water jets 523 carry the peel and albedo away from the process stream. The peel and albedo are removed by the transverse rollers 522, 522′ pushing the longitudinally cut peel rings 18 away from the equator 19 of the fruit. This is why it is important that the fruit be aligned before slitting the peel and on entering the brusher. Bed roller widths of 6 feet (1.8 metres) to 9 feet (2.7 metres) have been found to be preferable.

The peeled whole fruit 90 is conveyed, through a wide tube 601, to the segmenter 610 for segmentation and cleaning. The fruit 90 is deposited by the wide tube 601 onto two rotating drums 611, 611′ so that the fruit drops into a valley 612 between the fast revolving drums or cylinders 611, 611′. The revolving fruit is sprayed by water jets 613 from above. It is found that at a speed of 1200 rpm for oranges, and 2500 rpm for grapefruit, for example, centripetal forces separate, step 6100, the segments away from each other so that the segments fall through the valley 612 between the spaced apart drums 611, 611′. The fast revolving motion of the fruit also spins off any strings of vascular bundles that cover the fruit's surface. Consequently the segments emerge clean from the segmenter, within segment membranes.

The segments fall from the segmenter into a water conveyor (not shown) to be passed, step 6200, into the acid bath 620. Within about 3 minutes in the acid bath the acid dissolves pectin to loosen the membranes covering the segments. After draining for 30 seconds the segments are conveyed by the first draining conveyor 621 to an alkaline bath 630 to neutralise, step 6300, any remaining acid on the segments. The alkali also dissolves, within about 3 minutes, any hemi-cellulose and cellulose on the segments, leaving the segment relatively clean of membrane.

The segments are again drained for about 30 seconds before being conveyed by the second draining conveyor 631 to a first chilled water bath 642. The segments are immersed in cold water in the bath which removes any remaining alkali and firms up the segments. The segments are gently agitated in the first chilled water bath 642 by the agitator 643 to clean away any remnants of the membranes. The segments are then rinsed in plural baths 644 of clean cold water to remove all traces of the alkali and membranes. The segments are conveyed by conveyor 633 to the second chilled water bath 646 where the segments are chilled, step 6400, to 2° C. The segments are drained and excess moisture removed with air knives 649. The segments are misted by the mister 651 with ascorbic acid and citrus oil, before packing.

The optimum conditions for long shelf-life are found to be that the segments be chilled to a low temperature of 0° C. to 2° C., at a humidity of 95%, with no water film on the surface of the segments, that a low carbon dioxide content of packaging is used and the surfaces of the segments are coated with a mist of ascorbic acid 0.5% and citrus oil 0.5%. The citrus oil acts as a preservative and may enhance the organoleptic properties of the citrus segments.

Since there is no significant temperature elevation during the processing, the flavenoids and vitamin C are retained in the fruit segments. With the avoidance of use of enzymes, the segments are firm, undamaged and offer a longer shelf life than segments of the prior art, without becoming slimy. Moreover, there is no requirement for the pulsed pressure methods used in the prior art.

The quality of segments produced varies with the water pressure used in the pressure vessel for water infusion. At 40 bar (4000 kPa), the quality of citrus segments is better than the quality of segments processed at 20 bar (2000 kPa). Citrus segments processed at 110 bar (11,000 kPa) are significantly better than those processed at 40 bar (4000 kPa). However, at 210 bar (21,000 kPa) there is impairment of the quality of the segments. It is noticed that segments “weep” or lose their juices and the fruit is soft. It is also noted that water imbues into the fruit.

Moreover, high-pressure water infusion processing shortens the chemical processing time required for the citrus segments by more than 5 times. If citrus segments prepared at 4 bar (400 kPa) water infusion are treated with the acidic and alkaline process at 50° C., 10 minutes are taken for the acidic process to remove pectin and 11 minutes for the alkaline process to dissolve hemi-cellular and cellulose on the segments. However, citrus segments prepared at 40 bar (4000 kpa) water infusion take only 1.5 minutes for the acidic process and 2 minutes for the alkaline process.

Alternatively, high pressure water infusion allows lower concentrations of acids and alkalis to be used, at the same processing temperature of 50° C. Citrus segments prepared at 40 bar (4000 kPa) water infusion, are processed satisfactorily using half of the concentration of the acids and the alkali. However, citrus segments prepared at 4 bar (400 kPa) water infusion cannot be treated satisfactorily at these lower concentrations of the acids and the alkali.

In addition, citrus segments are more easily and cleanly separated at the segmenting rollers when high water pressure infusion is utilised e.g. 40 bar-120 bar (4000 kPa-12,000 kPa). It is noted that orange segments can be obtained from the segmenting rollers at speeds of only 800 rpm after infusion between 40 bar-120 bar (4000 kPa-12,000 kPa). Using lower water infusion pressures e.g. 20 bars (2000 kPa), the speed of the segmenting rollers has to be increased to 1800 rpm.

The cost of building equipment capable of working at around 100 bar (10,000 kPa) escalates rapidly and exceed the savings to be made in time and on expenditure for chemicals. It, therefore, proves most economical to use pressure of water infusion of 40-50 bar (4000-5000 kPa).

1. A method for preparing citrus fruit including the steps of:
a) providing (step 1000) a citrus fruit (10) having a flesh portion (11), an albedo portion (12), a peel portion (13) and a longitudinal axis (14);
b) piercing the peel portion (13) to provide access (step 2000) to the albedo portion (12) without piercing the flesh portion (11);
c) submerging the fruit (10) in a liquid under vacuum to extract (step 3000) air from the albedo portion (12);
d) subjecting (step 4000) the fruit (10) submerged in the liquid to pressure to produce infused fruit (70) in which the peel portion (13) and the albedo portion (12) are loosened from the fruit portion (11);
e) removing (step 5000) the peel portion (13) and the albedo portion (12) from the fruit portion (11) to produce peeled fruit (90); and
f) preparing (step 6000) the fruit portion (11) for consumption or storage.

2. A method as claimed in claim 1, wherein the step a) of providing a citrus fruit (10) includes washing (step 1100) the fruit.

3. A method as claimed in claim 2, wherein the washing step includes the steps of wetting the peel portion (13) with water and detergent, and brushing the peel portion and rinsing the peel portion with water.

4. A method as claimed in any of the preceding claims wherein the step a) of providing a fruit (10) includes a step of grading (step 1200) the fruit by size.

5. A method as claimed in any of the preceding claims, wherein the step b) of piercing the peel portion to provide access to the albedo portion includes cutting (step 2000) through the peel portion (13) into the albedo portion (12) to produce slit fruit (60) so as to facilitate subsequent removal of the peel and albedo portions from the fruit portion (11) of the slit fruit.

6. A method as claimed in claim 5, wherein the step of cutting (step 2000) through the peel portion (13) comprises cutting the peel portion with latitudinal cuts (17) transverse to the longitudinal axis (14) to form rings of peel (18).

7. A method as claimed in any of the previous claims wherein the step c) of submerging the fruit in a fluid under vacuum comprises submerging the fruit (10) under water in a vacuum in the range 51-100 kPa below atmospheric pressure.

8. A method as claimed in claim 7, wherein the step c) of submerging the fruit (10) in a fluid under vacuum comprises submerging the fruit under water in a vacuum of about 95 kPa below atmospheric pressure.

9. A method as claimed in any of the preceding claims wherein the step d) of subjecting (step 4000) the fruit submerged in the fluid to pressure comprises subjecting the fruit to a pressure in the range 400 kPa to 20,000 kPa.

10. A method as claimed in claim 9, wherein the step d) of subjecting the fruit submerged in the fluid to pressure comprises subjecting the fruit to a pressure of about 4,000 kPa.

11. A method as claimed in any of the preceding claims, wherein the step e) of removing (step 5000) the peel portion (13) and the albedo portion (12) from the fruit portion (11) includes pressing (step 5100) the infused fruit (70) a predetermined amount to loosen the peel portion and the albedo portion from the fruit portion to produce pressed fruit (80).

12. A method as claimed in claim 11, wherein the step of pressing (step 5100) the infused fruit includes passing the infused fruit (70) between brush rollers (511) and contoured bars (512) separated from the brush rollers by a distance 1 cm to 3 cm less than a diameter of the infused fruit (70).

13. A method as claimed in any of the preceding claims, wherein the step e) of removing (step 5200) the peel portion (13) and the albedo portion (12) from the fruit portion (11) includes brushing the peal portion and albedo portion from the fruit portion.

14. A method as claimed in claim 13 wherein the step of brushing the peel portion and albedo portion from the fruit portion comprises brushing the fruit in a direction substantially parallel with the longitudinal axis (14).

15. A method as claimed in any of the preceding claims, wherein the step f) of preparing (step 6000) the fruit portion (11) for consumption or storage includes segmenting (step 6100) the fruit portion into segments.

16. A method as claimed in claim 15 wherein the step of segmenting the fruit portion into segments comprises rotating the peeled fruit (90) about the longitudinal axis (14) of the fruit to separate the segments centrifugally.

17. A method as claimed in any of the preceding claims, wherein the step f) of preparing the fruit portion for consumption or storage (step 6000) comprises the further step of removing outer membranes from the segments with acid (step 6200).

18. A method as claimed in claim 17, wherein the further step of removing outer membranes from the segments with acid comprises removing the outer membranes with dilute citric acid and/or dilute hydrochloric acid.

19. A method as claimed in claim 18, wherein the step of removing the outer membranes with dilute citric acid and/or dilute hydrochloric acid comprises passing the segments for 1-3 minutes through a bath containing a solution in the proportions of 1 gm of citric acid: 100-200 ml of water: 5 ml dilute hydrochloric acid, the solution having a pH in the range 0.88 to 0.91.

20. A method as claimed in any of claims 17 to 19, wherein the step of removing the membranes with acid comprises the further steps of draining acid from the segments and neutralising (step 6300) any of the acid by immersing the segments in an alkaline solution.

21. A method as claimed in claim 20, wherein the step of immersing the segments in an alkaline solution includes the step of dissolving any remaining segment membrane in the alkaline solution.

22. A method as claimed in claims 20 or 21, wherein immersing the segments in an alkaline solution comprises immersing the segments in dilute sodium hydroxide at a temperature in the range 50° C. to 60° C. for 1-3 minutes.

23. A method as claimed in any of claims 15 to 22, wherein the step f) of preparing the fruit for consumption or storage (step 6000) includes agitating and rinsing the segments in cold water.

24. A method as claimed in any of claims 15 to 23, wherein the step f) of preparing the fruit for consumption or storage (step 6000) includes chilling (step 6400) the segments in cold water, drying the segments and coating (step 6500) the segments.

25. A method as claimed in claim 24 wherein the step of chilling (step 6400) the segments in cold water comprises chilling the segments in water at a temperature in the range 0° C. to 2° C.

26. A method as claimed in claims 24 or 25, wherein the step of coating (step 6500) the segments comprises coating the segments with ascorbic acid 0.5% and/or citrus oil 0.5%.

27. An apparatus for preparing citrus fruit (10) having a longitudinal axis (14), a peel portion (13), an albedo portion (12) containing air sacs, and a fruit portion (11), the apparatus comprising:
cutter means (200) having knife means (203) for cutting through the peel portion and into the albedo portion, and having depth control means (214) for preventing blade means (215) of the knife means penetrating the fruit portion, for cutting substantially parallel latitudinal circumferential cuts (17) through the peel portion into the albedo portion to form peel rings (18) transverse to the longitudinal axis (14);
vacuum means (332,333) for extracting air from the air sacs to form at least partially evacuated air sacs;
pressure means (342,343) for infusing liquid under pressure into the at least partially evacuated air sacs to loosen the peel rings and albedo portion from the fruit portion;
brush means (520) having a brush longitudinal axis substantially perpendicular to the fruit longitudinal axis (14) for brushing the peel rings and albedo portion off the fruit portion; and
centrifugal segmentation means (610) for rotating the fruit portion about the fruit longitudinal axis to separate the fruit portion into the constituent segments thereof by centripetal forces.

28. A cutter (200) for providing access to the albedo portion of a citrus fruit, the cutter being for use in the method of any of claims 1 to 26 and comprising: conveyor and rotator means (201) for conveying fruit through the cutter and for rotating the fruit (10) about a longitudinal axis (14) thereof; an array of cutter knives (203) biased towards the conveyor and rotator means (201) for cutting a plurality of latitudinal slits (17), transverse to the longitudinal axis, through the peel portion (13) and into the albedo portion (12); and depth control means (214) for preventing the cutter knives (203) piercing the fruit portion (11).

29. A cutter as claimed in claim 28, wherein the cutter knives (203) each comprise an L-shaped blade holder (213) having a first arm and a second arm shorter than the first arm, the first arm housing a protruding blade (215); the blade holder being pivotable about a pivot point adjacent a junction between the first arm and the second arm; and the cutter further comprising: pivot means (212) passing through the pivot point; bias means (204) acting on the second arm to bias the first arm towards the conveyor and rotator means (201); and stop means (206) such that the blade holder is rotatable about the pivot point between a rest position in which the second arm abuts the stop means to limit downward rotation of the first arm and an upper position in which the first arm abuts the stop means to limit upward rotation of the first arm.

30. A cutter as claimed in claims 28 or 29, wherein the depth control means comprises a shoulder (214) between the blade holder (213) and the blade (215) for engaging an outer surface of the peel (13) to allow the blade to penetrate only a predetermined distance through the peel portion and into the albedo portion.

31. An infuser (300) for use in the method of any of claims 1 to 26, the infuser comprising: an evacuation and pressure vessel (310); a vacuum reservoir (332) connectable to the evacuation and pressure vessel rapidly partially to evacuate the evacuation and pressure vessel, the vacuum reservoir being evacuable by a vacuum pump (333) connectable thereto; a pressure pump (343) connectable to the evacuation and pressure vessel for filling the evacuation and pressure vessel with a liquid under pressure; and pressure release means (321) for permitting the liquid in the evacuation and pressure vessel to be returned to atmospheric pressure.

32. A roller presser (510) for use in the method of any of claims 11 to 26, the roller presser comprising brush rollers (511) and contoured bars (512) separated from the brush rollers by a distance 1-3 cm less than a diameter of infused fruit (60) to be pressed, such that the fruit is pressed a predetermined amount as the fruit is passed between the rollers and the contoured bars.

33. A brusher (520) for use in the method of any of claims 13 to 26, wherein the brusher includes parallel roller brushes (521,521′), each roller brush having a roller brush rotational axis, the roller brushes being for conveying fruit (80) through the brusher and wherein the brusher further includes two counter-rotatable transverse brushes (522,522′) having substantially parallel transverse brush rotational axis, wherein the transverse brush rotational axes are substantially transverse to the roller brush rotational axes and substantially parallel to a direction of motion of fruit through the brusher, such that when fruit is passed between a roller brush and the two transverse brushes the transverse brushes act to brush peel and albedo portions from a fruit portion of the fruit.

34. A segmenter (610) for use in the method of any of claims 15 to 26, wherein the segmenter includes: two spaced apart rotatable drums (611,611′) defining a valley (612) therebetween, delivery means (601) for delivering peeled fruit (90) to the valley for rotation by the drums therein, such that centripetal forces set up by rotation of the fruit by the drums causes the peeled fruit to divide into constituent segments thereof.

35. A segmenter as claimed in claim 34 further including water jet means (613) for spraying the rotating fruit with water to assist in passage of the segments through the valley (612).

36. An acid for use in an acid bath (620) for use in the method of any of claims 17 to 26, comprising a mixture in the proportions of 1 gm of citric acid: 100-200 ml of water: 5 ml dilute hydrochloric acid, the solution having a pH in the range 0.88 to 0.91.

37. An alkaline solution used in the alkali bath (630) used in the method of any of claims 20 to 26, obtainable by dissolving sodium hydroxide crystals in water in the proportion of 1 gm of sodium hydroxide crystals to 100 ml of water.

38. A coating for coating segments of citrus fruit for use in the method of any of claims 24 to 26, the coating comprising ascorbic acid 0.5% and citrus oil 0.5%.
